(19) United States
(12) Patent Application Publication
(10) Pub. No.: US 2018/0236377 A1
(43) Pub. Date: Aug. 23, 2018

(54) APPLICATIONS OF MICROWAVE RADIATION TO CHROMATOGRAPHIC SEPARATIONS

(71) Applicant: Mark A. Stone, San Rafael, CA (US)

(72) Inventor: Mark A. Stone, San Rafael, CA (US)

(21) Appl. No.: 15/901,780

(22) Filed: Feb. 21, 2018

Related U.S. Application Data
(60) Provisional application No. 62/461,377, filed on Feb. 21, 2017.

(51) Int. Cl. B01D 15/18; B01D 15/34; B01D 15/40; H05B 6/80

(52) U.S. Cl. CPC B01D 15/18; H05B 6/806; B01D 15/40; B01D 15/34

(57) ABSTRACT

A method of applying microwave radiation to a chromatography column to achieve turbulent chromatography, increase the speed of column equilibration following a change of mobile phase, facilitate faster mixing of fluids, reduce the viscosity of fluids, and apply temperature pulses to selected time segments of a separation. The method may be used in conjunction with the use of columns packed with fused-core particles or monolithic columns. Improved size-based separations may be achieved using diffusion-and-turbulent-dependent size exclusion chromatography.

### CROSS REFERENCES TO RELATED APPLICATIONS

The present application claims the benefit of U.S. Provisional Patent Application Ser. No. 62/461,377, filed Feb. 21, 2017 (Feb. 21, 2017).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

### Field of the Invention

The invention relates most generally to chemical separation techniques, more particularly to chromatographic separation technologies, and still more particularly to liquid chromatography and supercritical fluid chromatography. The invention relates specifically to the use of microwave energy to improve chromatographic separations.

### Background Discussion

The beneficial effects that microwave energy can have on chromatographic separations has previously been described (U.S. Pat. No. 6,630,354 B2 to Stone, 2003 (“Stone '354”, incorporated in its entirety by reference herein); Galinada and Guiochon, 2005; Galinada and Guiochon 2005, Galinada, Kaczmarski, and Guiochon 2005, Terol, Maestre, Prats, and Todoli, 2012; Carballo, Prats, Maestre, and Todoli, 2015). Stone '354 describes how, by increasing the diffusivity of the analytes and/or the mobile phase, microwave radiation can increase the speed of liquid chromatography and supercritical fluid chromatography, as well as making it possible to conduct these modes of separation in open tubular columns. The present patent application will describe several additional benefits that microwave radiation can offer to improve chromatographic separations.

Although chromatographic methods are among the most versatile and powerful methods of analysis, they are slow when compared to other techniques. There are two primary approaches used to increase the speed of liquid chromatography. A first is to utilize smaller diameter particles in the column, which typically results in very high pressures and, therefore, is referred to as ultra high pressure liquid chromatography (UHPLC). A second is high temperature liquid chromatography (HTLC), so called as it relies on elevating the temperature at which the separation takes place. However, both approaches introduce technical challenges. When running UHPLC methods, radial temperature gradients can develop in the column, due to the significant degree of viscous heating that occurs when fluid is pumped through a column at higher pressures. Therefore, the analyst is forced to use smaller internal diameter columns, which more readily dissipate the heat. As a result of the smaller diameter columns, the smaller particles, and the shorter column lengths typically used, the volume of the chromatographic peaks are very small. Consequently, UHPLC separations are far more susceptible to extra column effects, such as the broadening of chromatographic peaks due to dead volume in the fittings or due to the length and diameter of the connecting tubing. FIG. 1 depicts a packed column 10, such as might be used for liquid or supercritical fluid separations, and indicates what is meant by the terms discussed above. Specifically, the particle diameter 12 (dp) is the diameter of the particles that are packed into the column, and the internal diameter ID and length L are the dimensions of the column itself. It should be noted that the figure is merely intended to be a highly schematic representation of a packed column: for clarity, the particles are drawn much larger, in relation to the dimensions of the column than would actually be the case.

An additional technical challenge when using UHPLC is in keeping large complex molecules intact. Larger molecules, such as proteins and polymers, are known to undergo degradation due to shearing effects when run at ultra high pressures, and columns packed with small diameter particles are far more susceptible to plugging by any undissolved material that may be present.

A different set of problems exist when conducting chromatographic separations at elevated temperatures. These include instability of both the analytes and the column stationary phase, at the elevated temperatures, as well as the need for additional hardware to pre-heat the mobile phase prior to reaching the column, to cool the mobile phase back to near ambient temperature prior to entering the detector, and to maintain back pressure on the column in order to prevent boiling of the mobile phase.

In his text, “Dynamics of Chromatography” (1965) Giddings suggested another approach to achieve high speed chromatography. Specifically, he predicted that it would be beneficial to conduct chromatographic separations under conditions where the mobile phase is undergoing turbulent flow, as opposed to the more common laminar flow. The use of turbulent flow would allow for fast separations without the difficulties mentioned above, for the currently used methods for obtaining high speed chromatography. The first embodiment of the present invention is a method for successfully utilizing turbulent flow for chromatographic separations. Therefore, a discussion of the principles of turbulent chromatography, and the reasons for the limited success with turbulent chromatography, thus far, are relevant and considered in the following paragraphs.

Classical Picture of Turbulent Chromatography:

Under laminar flow conditions the bulk fluid is moving in essentially straight lines, with diffusional motion, primarily, causing molecules to deviate from this. Conversely, turbulent flow has been defined as “chaotic three dimensional fluctuations of molecules in adjacent fluid layers with time” (Evett and Liu, 1987). The difference between these two flow regimes was depicted, in one publication, using dye (Johannesen and Lowe, 1982). The dye enabled direct visual observation of the nature of laminar vs turbulent flow. A rendering of the schematic FIG. 20 from this publication is provided as FIG. 2, illustrating the difference between laminar and turbulent flow. The left portion 22 of the figure depicts the dye moving through the capillary 24 when the flow is laminar, and the right portion of the FIG. 26 depicts the same when the fluid is turbulent. (For FIGS. 2 through 7, fluid should be thought to be flowing through a narrow capillary—such as an open-tubular column—from left to right.)

The transition from laminar to turbulent flow takes place under conditions that can be roughly predicted by a unitless parameter called the Reynolds Number (Rₑ). The Reynolds Number is defined as follows for open-tubular columns: where μ is the linear velocity of the fluid, ρ is the density of the fluid, ID is the internal diameter of the column, and η is the dynamic viscosity of the fluid (Herman, Edge, 2012).

Rₑ=μρID/η [1]

For packed columns the Reynolds Number is defined as follows: where dₚ is the diameter of the particles packed into the column, εₒ is the external porosity of the column, and other parameters are as defined above (Herman, Edge, 2012).

Rₑ=μρdp/ηεₒ [2]

With respect to equations [1] and [2], it has generally been found that turbulent flow is achieved in open tubular columns with a smooth surface at Reynolds Numbers between 2000-3000, and that the transition from laminar to turbulent flow is generally fairly abrupt. By contrast, for packed columns it has been reported that turbulence develops more gradually, usually beginning when the Reynolds number goes above a value of 1, with completely turbulent flow developing by the time the Reynolds number reaches 10 (JJ. Van Deemter, 1962). FIG. 3 depicts the parabolic laminar flow profile 30 that one observes when fluid is pumped through a capillary 32 under a laminar flow regime. Due to the frictional drag from the wall, the solutes traveling close to the wall move at a lower velocity than the solutes traveling farther from the wall. This results in band broadening due to what is referred to as the mobile phase mass transfer mechanism. As seen in FIG. 4, this can be visualized by considering two molecules, A 40 and B 42, traveling through the column 44 under laminar flow conditions. Due to the nature of laminar flow, the molecules are moving in relatively straight lines 46, 48 with diffusional motion, primarily, causing them to deviate from this. Therefore, if a given molecule (A in the figure) spends the majority of time in regions close to the wall, and another molecule (B in the figure) spends the majority of time in regions closer to the center of the capillary, then molecule B will move through the column with a higher average linear velocity than molecule A. The result is a spreading of the solute band, which shortens and widens the chromatographic peaks; therefore, it has a negative effect on the resolution, speed, and sensitivity of the separation.

One of the unique aspects of turbulent flow is the relatively flat flow profile obtained. This occurs as the chaotic nature of turbulent flow results in enhanced radial mass transfer. The effect is that each mobile phase molecule spends time in different radial regions of the column. In simple terms, the mobile phase molecules “take turns” traveling near the wall. As a result, under a turbulent flow regime a much flatter flow profile 50 is observed. This is shown schematically in FIG. 5.

In addition to being chromatographically beneficial, the flat flow profile is also advantageous because it allows faster equilibration when the mobile phase is changed, allowing faster gradients to be used and making step gradients much more feasible. It is also beneficial in any situation in which it is desired to transfer a volume of fluid with minimal mixing into the “carrier fluid” in which it is being transferred.

Logically, this enhanced radial mass transfer is also observed for the analyte molecules. FIG. 6 schematically shows a column 60 with two analytes, A 62 and B 64, moving through the column under turbulent conditions. The fact that the radial mass transfer of the analyte molecules is enhanced is additionally beneficial to the chromatographic separation. Because the analyte molecules are spending time in different radial regions of the column, the average velocity of all analyte molecules becomes roughly equivalent. In other words, the enhanced radial mass transfer of the analytes helps reduce band broadening due to any residual “lack of flatness” (or parabolic curvature) that still remains in the flow profile.

In his text, Giddings predicted that much faster separations could be accomplished under turbulent flow conditions due to the combination of the flat flow profile and the enhanced radial mass transfer of the analytes. Furthermore, under turbulent conditions fast chromatography should be achievable when using packed columns with fairly large particle diameters, therefore requiring neither excessive pressures nor temperatures. Similarly, the possibility of using open-tubular columns for liquid or supercritical fluid chromatography becomes feasible. Although literature exists on the use of open tubular columns for these techniques, such columns are rarely used in practice, as a significant degree of band broadening is observed due to the mobile phase mass transfer mechanism (which is more significant in open tubular columns due to the wider flow channels).

Parallels should be noted between the benefits described for chromatography under a turbulent flow regime and those of high temperature liquid chromatography and ultra high pressure liquid chromatography (again, given as HTLC and UHPLC, respectively). The increased mass transfer has the same effect as elevating the diffusivity of the mobile phase, which is the primary benefit obtained from HTLC. And the flattening of the flow profile accomplishes the same goal as one seeks to obtain when going to smaller diameter particles in UHPLC. As the diameter of the particles decreases so does the diameter of the flow channels between the particles, and so there is less variation in the linear velocities across these narrower channels. This suggests that by running chromatography under turbulent conditions we stand to obtain the benefits of both HTLC and UHPLC.

Subsequent to the publication of “Dynamics of Chromatography,” many researchers sought to understand and take advantage of the benefits of turbulence in the laboratory. However, they observed that while faster analysis was possible, it was only for unretained, or very weakly retained, analytes. Given that the ultimate goal of chromatographic methods is to achieve separation, and this will only occur when the analytes are sufficiently retained, turbulent chromatography was ultimately determined to be of no practical value. The reason the benefits of turbulent chromatography do not extend to retained analytes is understood: it is due to two conditions. The first is the band broadening due to stationary phase mass transfer, which is not helped by turbulent flow as the mass transfer within the stationary phase, and especially within the pores, is still a slow diffusion-driven process. The second is that it has not been possible to obtain a completely turbulent mobile phase.

Regarding the inability to date to obtain a completely turbulent mobile phase, models have been developed showing that when turbulent flow conditions are reached, there remains a thin layer of liquid at the surface of the stationary phase, which stays in a laminar flow regime. Hence there are, in effect, two discreet mobile phases; consequently, there is an additional mechanism of band broadening that occurs each time an analyte molecule passes across the boundary layer and travels from one mobile phase region to the other. FIG. 7 illustrates this phenomenon as described in the literature (Golay et. al., 1990). As mentioned previously, these figures are drawn such that the fluid should be imagined to be flowing from left to right. The dashed lines 70 represent the boundary layer between the mobile phase 72 which is in the laminar flow state and the bulk mobile phase 74 which is in the turbulent flow state. The laminar state is predicted by the model to be a thin layer. Its size is exaggerated in the figure for clarity. The dotted line 76 depicts the nature of the fluid flow in the two regimes. In the laminar portion of the mobile phase the classic parabolic flow profile is observed, whereas in the portion of the mobile phase that is turbulent a fairly flat flow profile is observed (Golay et. al., 1990).

For unretained analytes this additional mechanism of band broadening is not very significant, as these analytes remain primarily in the mobile phase throughout their transit through the column and, therefore, do not pass through this boundary very often (as it is located close to the surface of the stationary phase). However, for retained analytes which continually pass back and forth from the mobile phase into the stationary phase and back again, thereby repeatedly passing through this boundary layer, the effect becomes significant and largely cancels out the beneficial effects of turbulent flow.

It should be noted that FIGS. 2 through 7 were drawn in open-tubular column configurations, as the phenomenon are easier to visualize this way. However, all the phenomenon described in these figures, and the associated text, are equally relevant to packed columns (of the type depicted in FIG. 2); the only difference is that in packed columns, the phenomena described are occurring in the channels between the particles.

Recent Observations Providing New Insights into Turbulent Chromatography:

Over 30 years after Giddings's original publication, data became available that provided two new insights into the nature of turbulent chromatography. The first is that the retention of large molecules decreases substantially when the flow becomes turbulent. The second is that the beneficial effects of turbulence, on chromatographic separations are more significant for large molecules.

Both of these insights come from data presented in two United States patents that were filed by Quinn et. al. (U.S. Pat. No. 5,772,874, Quinn and Takarewski, 1998; and U.S. Pat. No. 5,919,368 Quinn and Takarewski, 1999). The product ultimately developed from these patents (and currently sold as a ‘TurboFlow Column’) is primarily used and advertised for its differential retention properties. Specifically, when operated under turbulent conditions, reduced retention is observed for large molecules. Therefore, it is possible to preferentially retain small molecules and allow large molecules, such as proteins, to be rapidly eluted. The small molecules can then be analyzed free of the interferences that would have resulted from the large molecules. It should be noted that some researchers have suggested that the flow regime that occurs in these columns would more properly be characterized as non-laminar rather than turbulent. However, for our purposes the distinction is not critical; rather, what is important are the characteristics of the column once the flow is no longer laminar. Hence, the term “turbulent” as used herein should be understood to mean ‘turbulent or non-laminar’. It should also be noted that, while the aforementioned patents described the development of specific columns (now sold as ‘TurboFlow columns’), the following discussion makes clear that it is the nature of turbulent (or non-laminar) flow that is the cause of these phenomenon. Thus, there is nothing particularly unique about the TurboFlow columns, other than that they were designed to generate turbulent flow and to work at flow rates easily accommodated by conventional chromatography systems.

FIGS. 8-9 present two compelling examples of the drop in retention of large molecules under turbulent conditions. FIG. 8 shows data 80 relating the recoveries of lysozyme 84, methyl paraben 86, and ethyl paraben 88, as a function of flow rate. The data were obtained from a two-step experiment using a column coated with a hydrophobic stationary phase. In the first step, a large molecule (Lysozyme, with a molecular weight of 13,000 Da) and two small molecules (methylparaben and ethylparaben, with molecular weights of 152 and 166 Da, respectively) were injected onto the column with an aqueous mobile phase being pumped at various flow rates. In the second step, a hydrophobic solvent was used to elute the analytes that remained on the column (J. Takarewski, presented at 12th Desty Memorial Lecture for Innovation in Separation Science, London, 2007). The data show a remarkable drop in recovery (and, hence, retention) of the large molecule when the flow rate was increased above 1 mL/min. However, the small molecules are retained even at flow rates as high as 9 mL/min. It was suggested that the flow starts to become turbulent as the flow rate is increased above 1 mL/min.

A similar point is illustrated in FIG. 9, a graph 90 showing the percent removal of plasma proteins (y-axis 92) as a function of Reynolds Number (x-axis 94). In this experiment the efficiency of removal of plasma proteins, by elution through a hydrophobic column under aqueous loading conditions at different flow rates, was evaluated (W. D. van Dongen, R. Ramaker, F. van Schalk, B. Ooms, E. Koster, 25th Annual meeting of the British Mass Spectrometry Society, United Kingdom, 2001). This is similar to the experiment above, however, the results are reported in terms of the percentage of protein removed, instead of the quantity retained. The data show that protein removal increases dramatically (hence, retention decreases dramatically) as higher flow rates were used. Although flow rate was the parameter that was changed, the x-axis was reported in terms of the Reynolds number, so as to make clear that the dramatic increase in protein removal (hence, drop in retention) began at approximately the point where the Reynolds number becomes larger than 1, which is generally believed to be the point at which the mobile phase starts to enter the turbulent regime, in a packed column (J. J. Van Deemter, 1962).

FIGS. 8 and 9 show the difference in the behavior of large molecules and small molecules, under turbulent conditions. However, differences have also been reported between large molecules of different size ranges. For example, FIG. 14 is a table 140 showing the flow rate needed to remove proteins of various molecular weights (Herman, Edge, 2012). The experiment from which the data were obtained was conducted in a manner similar to the experiments described above, with the mobile phase in the turbulent regime. The data show that the larger proteins had less retention than the smaller proteins and, therefore, that higher flow rates were needed to remove the smaller proteins.

To understand the effect of molecular size on retention it is useful to first consider the diffusivities of molecules as a function of molecular weight. The diffusivity of large molecules is typically in the range of 10 times lower than the diffusivity of small molecules (for example, the diffusion coefficient of sucrose is 0.52 and that of Serum Albumin is 0.059; units of 10⁻⁹ m²/s). During a chromatographic separation under conventional laminar conditions, solutes move from the mobile phase to the stationary phase (and back again) primarily by diffusion. One may then conclude that larger solutes would take longer to reach the stationary phase and, therefore, at a sufficiently high flow rate they would be less retained, simply due to their lower rates of diffusion. However, reports of separations as a function of size due to this diffusional mechanism (under laminar flow conditions and in a particle packed column) are evidently absent from the literature. This may be due to the fact that the direction of diffusional motion continually and randomly changes. Therefore, despite the higher rates of diffusion, a significant interval of time is still required for a small molecule to cover a given distance, under laminar conditions, so as to reach the stationary phase. However, the data above show that a dramatic difference in the retention of small and large molecules does occur when the flow becomes turbulent. There are two arguments that are generally given for this. The first is that the enhanced radial mass transfer that results under turbulent conditions brings all analytes into frequent proximity to the stationary phase. When closer to the stationary phase, the small molecules can more readily exploit their higher diffusivities and can thus access the stationary phase more easily than can large molecules. The second explanation is that the eddies which form under turbulent conditions “carry” the analyte molecules along with them, in continually changing directions, and that in order to interact with the stationary phase, the analyte molecules must overcome the forces in the eddies. Due to their larger surface area, large molecules are more susceptible to the force of the eddies such that it is more difficult for them to do this (Edge, 2003; Chassaing, Robinson, 2009; Herman, Edge, 2012; Crouchman, 2012).

The combination of the inherently lower diffusivity of large molecules and the fact that they are more strongly controlled by the eddies does provide a logical explanation for the differences in retention. One may still wonder whether there may be yet another component in the explanation for the observed behavior. The arguments above would explain how large molecules are less able to diffuse into the pores under conditions of turbulent flow. However, given that the increased radial mass transfer brings all analytes into frequent proximity to the stationary phase, and given that pores are present ubiquitously throughout the stationary phase, it begs the question: what would prevent large molecules from being directly delivered to the pores by the turbulent mobile phase? We submit an additional mechanism based on the random formation of eddies in a turbulent mobile phase. More specifically, the fact that eddies may form at any location, at any time, and break in any direction. However, we suggest there will not be significant mass transfer associated with eddies that form near the surface of the stationary phase and which break in the direction of the stationary phase, as the presence of the stationary phase would either quench the energy of these eddies and/or quickly “rebound” any mass transfer that resulted from these eddies (somewhat like an ocean wave that breaks against a cement pier). It would follow that the preponderance of mass transfer near the surface of the stationary phase would be in the direction away from the stationary phase. Furthermore, it would be expected that this “pushing away” force would have a more significant effect on large molecules due to their much higher surface area.

Regardless of what combination of mechanisms is at work, there is clear empirical evidence that under turbulent conditions the retention of large molecules decreases significantly. This is also consistent with the observation that limited fouling is encountered under turbulent conditions (i.e., irreversible binding of proteins or other large molecules to the column, which shortens the life of the column). For example, it has been said that TurboFlow columns can tolerate direct injection of biological fluids, typically approaching 1000 samples, before a significant loss in chromatographic performance is seen (Edge, 2003).

The aforementioned patents (U.S. Pat. No. 5,772,874 to Quinn and Takarewski, 1998; and U.S. Pat. No. 5,919,368 to Quinn and Takarewski, 1999) also provided data suggesting that the band broadening of analyte peaks is an inverse function of the linear velocity of the mobile phase and the molecular weight of the analyte molecules. Both of these points are demonstrated in FIG. 10 (U.S. Pat. No. 5,919,368 to Quinn and Takarewski), which is a graph 100 plotting reduced plate height vs linear velocity for lysozyme with a molecular weight of 13,000 Da (top curve 102) and bovine serum albumin with a molecular weight of 67,000 Da (bottom curve 104). The data were generated from analysis conducted with a cation exchange column. It can be seen that the reduced plate height (h, y-axis) 106 comes down at higher linear velocities (cm/sec, x-axis) 108, indicating a sharpening of the analyte peaks, and that this effect is more significant for the larger molecule. The sharpening of analyte peaks as the linear velocity is increased into the turbulent regime is consistent with the classical picture of turbulent chromatography (assuming the analytes are minimally retained). However, the suggestion that the beneficial effects of turbulence are more significant for larger analytes is not something previously reported. Hence, this is the second of the new insights into the nature of turbulent chromatography that was provided by these patents.

Although an explanation for this phenomenon was not discussed in the patents, one may be suggested by returning to the earlier discussion of how, when a mobile phase becomes turbulent, there is a thin layer at the surface of the stationary phase which remains in the laminar regime (as was depicted in FIG. 7). We would suggest that small molecules are able to fully enter this thin laminar layer. However, due to their size, large molecules never completely leave the turbulent mobile phase. FIG. 11 is a variation of FIG. 7 which visually demonstrates this idea. This would explain how the benefits of turbulent chromatography could be more fully realized for large molecules, as they have little to no ability to interact with the laminar layer, which has been shown to rob the chromatographer of the benefits of turbulent chromatography (Golay et. al., 1990).

This observation suggests that the beneficial effect of turbulence could be achieved when dealing with molecules of sufficient size. Of course, one would also need to address the other factor that tends to prevent successful turbulent chromatography, i.e., band broadening due to stationary phase mass transfer. In the first embodiment of the present invention, it will be argued that the use of microwave radiation offers a solution to this issue; and that the use of a fused core or monolithic column may also be advisable as these column formats are known to minimize stationary phase mass transfer. In particular, the use of microwave radiation in combination with such column formats can provide the best opportunity to successfully accomplish turbulent chromatography.

It may be noted that the idea presented above (and depicted in FIG. 11) may further explain the drop in retention of large molecules under turbulent conditions. Previously in this disclosure it was stated that this was due the lower rates of diffusion of large molecules, their larger surface area, and a “pushing away” force that exists near the surface of the stationary phase. Referring to FIG. 11, there is shown a schematic diagram of a small and large molecule with respect to the laminar and turbulent regions of the mobile phase. However, the model 110 depicted in FIG. 11 suggests another factor, which is that the large molecules 112 cannot “escape” the turbulent mobile phase 114, whereas the small molecules 116 can; providing, perhaps, one more component to the explanation for the dependence of retention on molecular weight under turbulent conditions.

### Definitions

Throughout this disclosure, reference will be made to two techniques: (1) liquid chromatography; and (2) supercritical fluid chromatography. It should be noted that the term liquid chromatography also encompasses subcritical fluid chromatography as well as enhanced fluidity liquid chromatography.

The phase diagram for carbon dioxide 120 presented in FIG. 12 clarifies these terms. Although supercritical fluid chromatography can refer to any chromatographic separation where one is working above both the critical pressure and critical temperature of the mobile phase (indicated in the figure as the critical point), in most cases supercritical fluid chromatography is done with fluids that are gaseous under ambient conditions (most commonly carbon dioxide). In some cases, chromatography may be done with fluids that are gaseous under ambient conditions but where the temperature and pressure are such that the fluid is in the liquid state. In order to differentiate this from conventional liquid chromatography, the term subcritical fluid chromatography is typically used. Lastly, when conducting either supercritical or subcritical fluid chromatography, it has been a common practice to add fairly small percentages of conventional liquids, such as methanol, to change the properties of the fluid. It is now becoming more common to use higher quantities of such modifiers. The term enhanced fluidity liquid chromatography has been coined to refer to chromatography using fluids that are gaseous under ambient conditions, but where conventional liquids are added at levels≥50%. However, the term liquid chromatography will simply be used, in this application, to encompass all separations where the mobile phase is in the liquid state.

### BRIEF SUMMARY OF THE INVENTION

The present invention is a method of applying microwave radiation to a chromatography column to achieve turbulent chromatography, increase the speed of column equilibration following a change of mobile phase, facilitate faster mixing of fluids, reduce the viscosity of fluids, and apply temperature pulses to selected time segments of a separation.

In embodiments, a fused core column may be employed. A monolithic column may also be employed.

The mobile phase may include polar liquids, and the method may further include separating molecules according to their size, as with size exclusion chromatography. In such embodiments, the size exclusion may be accomplished using a column having pores that allow only molecules below a certain molecular weight to enter, and the separation may be run at a linear velocity sufficiently high to induce turbulent flow.

In other embodiments, applying microwave radiation may be performed only during the intervals within a separation where peak-free regions of the chromatogram are being eluted or only when non-critical peak pairs are being eluted.

In still other embodiments, the chromatography column and the stationary phase are constructed of materials that do not absorb microwave radiation, and the microwave radiation therefore directly heats only the mobile phase and the analytes, but not the column; thus temperature elevation to the column and stationary phase is due to convective heat transfer only.

The invention may also be considered an enthalpic method of enhancing turbulent column chromatography, comprising the steps of (1) providing a fused core or monolithic column; (2) applying microwave radiation to the chromatographic column; and (3) eluting analytes in order of molecular weight.

In other embodiments, the inventive method enhances turbulent column chromatography using microwave radiation applied to a chromatography column following a change of the mobile phase in a re-equilibration stage of a gradient run in either liquid or supercritical fluid chromatography so as to increase the rate of mass transfer and the speed of column equilibration.

In still other embodiments, the inventive method enhances turbulent column chromatography by applying microwave radiation to a chromatography column to increase the speed at which two or more liquid or supercritical phases mix uniformly.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a highly schematic diagram showing a packed chromatography column with particle diameter, internal column diameter, and column length indicated.

FIG. 2 is a schematic view showing the difference between laminar and turbulent flow.

FIG. 3 is a highly schematic view illustrating a laminar flow profile.

FIG. 4 is a highly schematic view showing two molecules traveling under laminar conditions in a column.

FIG. 5 is a schematic diagram showing the relatively flat flow profile obtained under turbulent flow conditions.

FIG. 6 is a schematic diagram showing two molecules traveling under turbulent flow conditions.

FIG. 7 is a schematic view showing laminar and turbulent mobile phase regions resulting under turbulent flow conditions.

FIG. 8 is a graph illustrating the recoveries of lysozyme and parabens as a function of flow rate.

FIG. 9 is a graph illustrating the percentage removal of plasma proteins as a function of Reynolds number.

FIG. 10 is a graph illustrating the reduced plate height vs linear velocity curves for lysozyme and bovine serum albumin.

FIG. 11 is a graph illustrating small and large molecules with respect to the laminar and turbulent regions of the mobile phase.

FIG. 12 is a graph illustrating the phase diagram of carbon dioxide.

FIG. 13 is a graph illustrating the prior art: viz., the sequential elution of α-chymotrypsinogen and lysozyme via step gradients on a cation exchange column.

FIG. 14 is a table showing the molecular weight range of proteins removed as a function of flow rate.

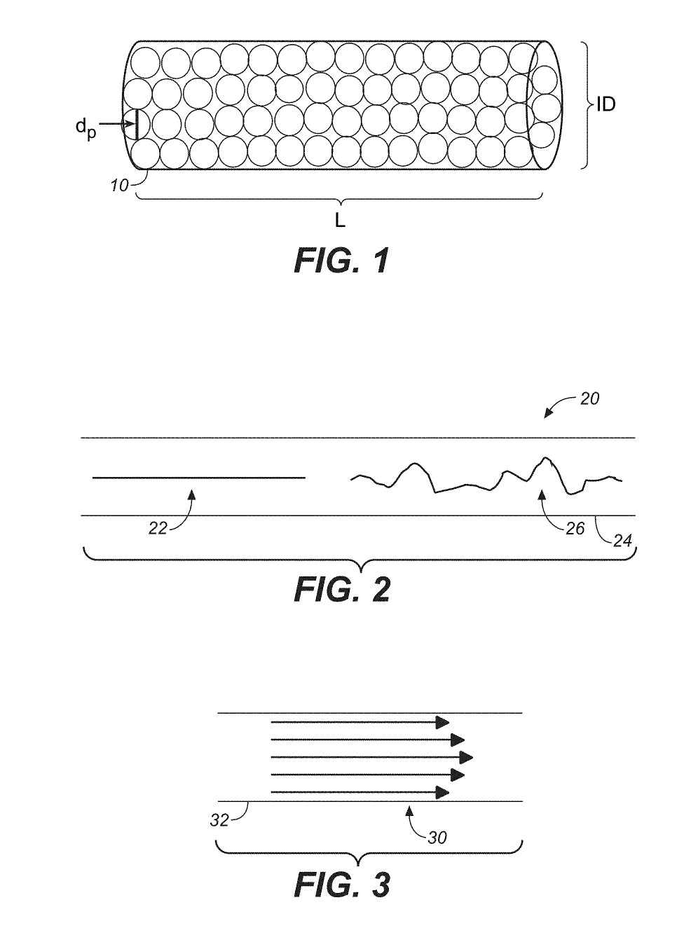

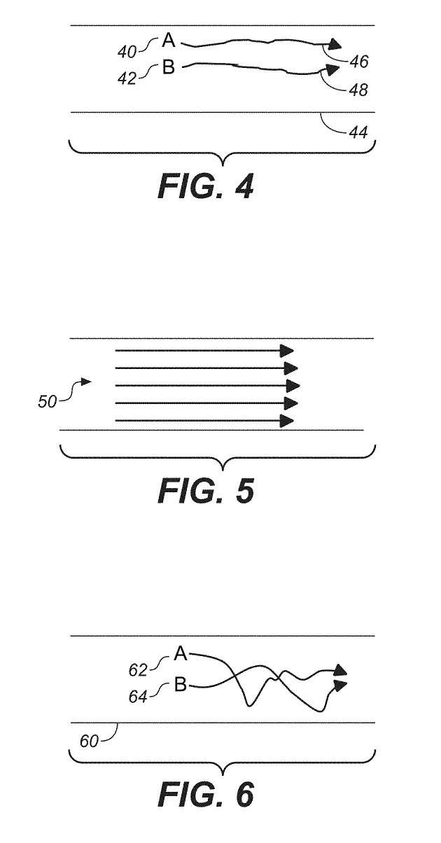

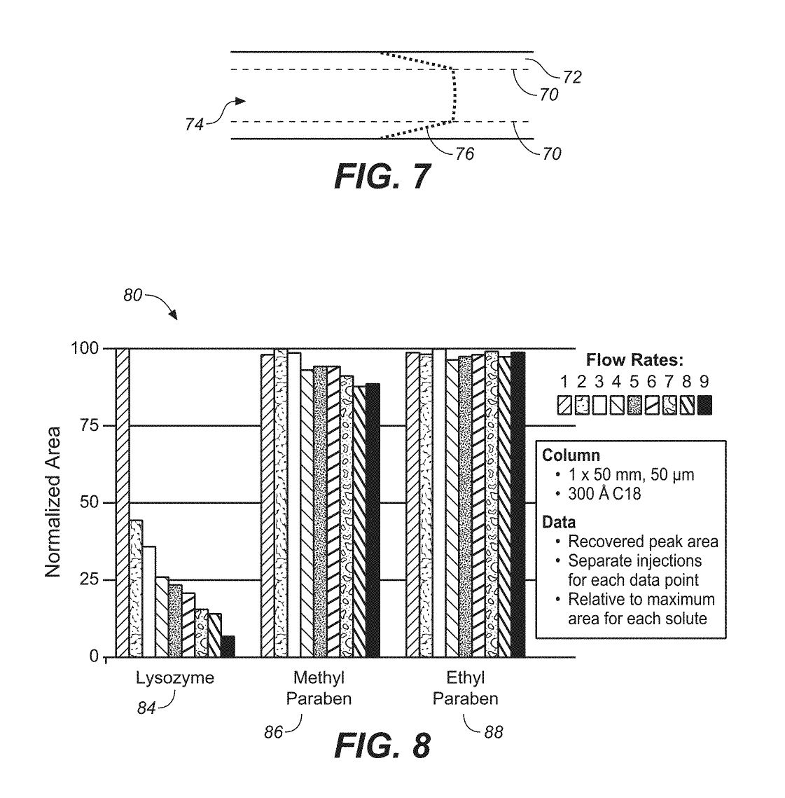

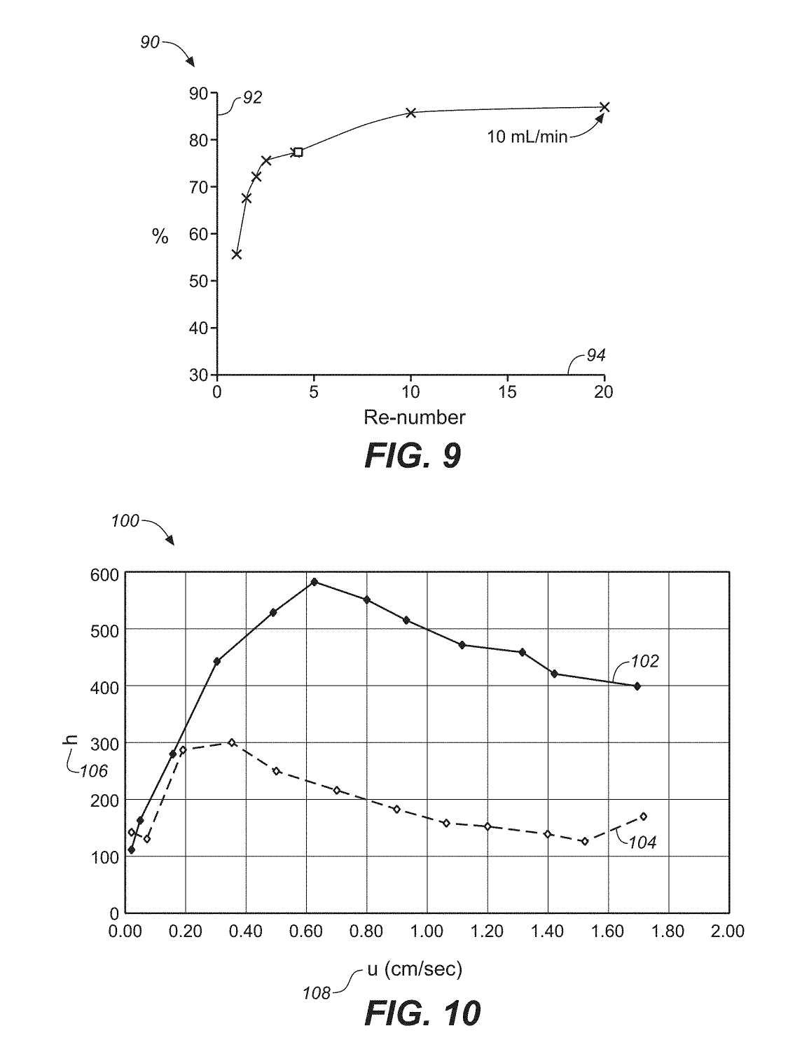

### DETAILED DESCRIPTION OF THE INVENTION

### First Embodiment: Microwave Enhanced Turbulent Chromatography

In what follows, it will be argued that successful turbulent chromatography can be obtained by applying microwave radiation, and when using a mode of separation where the direction of the separation is not inconsistent with that of turbulent chromatography (i.e., where large molecules elute first). In addition, the use of fused core or monolithic columns, in combination with these circumstances, is the best chance for achieving successful turbulent separations. As will be described in the next section, the microwave radiation serves two functions: the first is to minimize or reduce the residual laminar layer that exists within a turbulent mobile phase; and the second is to increase the molecular motion of the analytes within the stationary phase. In this way, it helps to address both of the fundamental issues that have impeded successful turbulent chromatography, historically.

Benefits of Microwave Radiation for Turbulent Separations:

As noted in the Background Discussion, above, there are two reasons that successful applications of turbulent chromatography have been limited to unretained or very weakly retained analytes. The first is that the benefits of turbulent flow do not extend to the stationary phase, and especially to the stationary phase located within the pores of the column. The mass transfer in the stationary phase is still a slow, diffusion-driven, process; and, therefore, there is significant band broadening due to the stationary phase mass transfer mechanism. The second is that it has not been possible to obtain a completely turbulent mobile phase.

In an embodiment of the present invention, denominated a first only to differentiate it from other embodiments but not otherwise signifying relative importance, microwave radiation is used to address these problems and, therefore, to allow the benefits of turbulent flow to be fully realized for liquid or supercritical fluid separations, for both retained and unretained solutes. This is something which has previously not been possible. Furthermore, the first embodiment of this application will introduce a chromatographic mode of separation that has not previously been used.

To accomplish microwave enhanced turbulent chromatography (METC) one conducts a liquid or supercritical fluid separation under conditions so as to induce turbulent flow, such as high flow rates and large diameter particles which have a rough surface; while simultaneously, applying microwave radiation to the column. When microwave radiation is applied to polar liquids, a substantial degree of molecular motion is generated due, primarily, to the dielectric polarization mechanism. This is the same phenomenon that results in heating of polar liquids by microwave radiation. The energy that is delivered by this effect is substantial such that, for example, water in a small test tube will boil in less than 10 seconds. When the radiation is applied to a chromatographic system, one effect may be to enhance the molecular motion of the mobile phase molecules which will, in turn, cause increased molecular motion of the analyte molecules. And, when dealing with analytes having some polarity, the radiation may have a direct effect on the analytes as well. The increased molecular motion that results from these effects is particularly important with respect to the liquid in the pores of the column. As stated previously, there is only slow diffusion-driven motion in the pores, as the benefits of turbulent flow are only realized for the flowing portion of the mobile phase. Therefore, there is a significant band broadening contribution due to the stationary phase mass transfer mechanism, in the absence of microwave radiation.

To further minimize the concern of stationary phase mass transfer, use may also be made of a column composed of pellicular (or fused core) particles where only the outer portion of the particle is porous. It is well known that such particles reduce the stationary phase mass transfer contribution to band broadening, especially for large molecules. Use of monolithic columns may also be an option provided that turbulent flow can be readily achieved, and it may be beneficial to construct a monolith of higher than normal porosity for this purpose. Non-porous or open-tubular columns may be an option, in certain situation, although there may be a significant loss of loadability and retention with such columns.

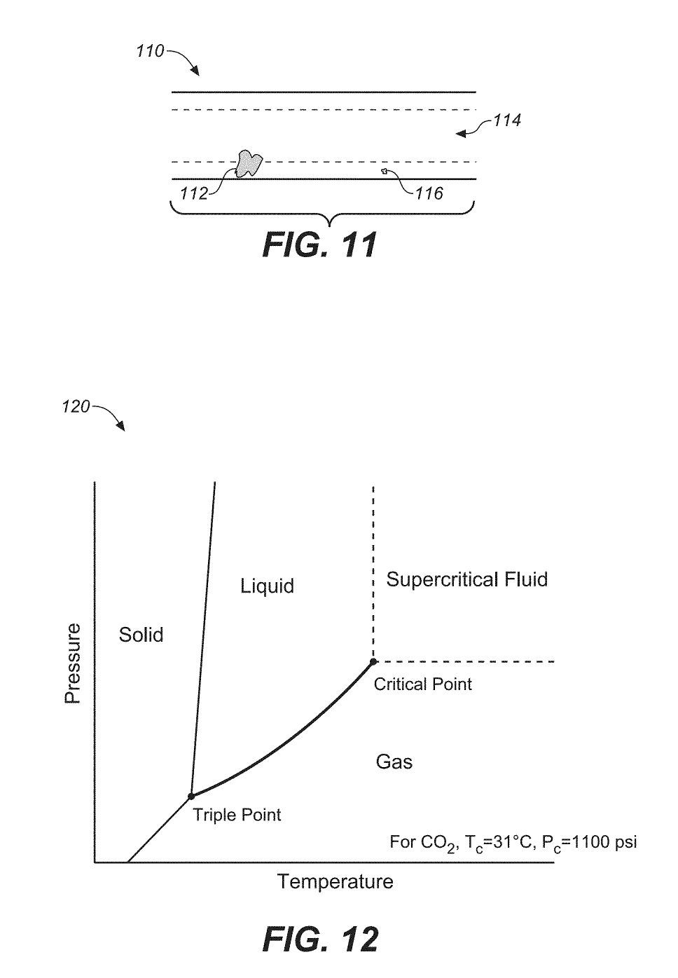

A second advantage in using microwave energy is to create a substantial “mixing effect” which results in the laminar layer mixing into the bulk turbulent layer, such that a thinner laminar layer results. Or, optimally, the laminar layer is entirely mixed into the turbulent mobile phase such that one continuous, turbulent, mobile phase is obtained. By virtue of this effect, the second limitation in successfully utilizing turbulent chromatography—the detrimental effect of the residual laminar layer—is addressed. However, and reiterating an earlier note above, the second of the more recent insights into turbulent chromatography is that large molecules realize a greater reduction in mobile phase mass transfer than small molecules. The present inventor believes this is due to the fact that they cannot fully enter the thin laminar layer (see FIG. 11). Thus, for large molecules it is expected that this would not be a concern, though it is not yet known how large a molecule must be for this to be realized. However, the data shown in FIG. 10 suggest it may be somewhere between 13,000 and 64,000 Da.

There are further advantages of microwave enhanced turbulent chromatography over classical turbulent chromatography. First, the microwave radiation further increases the mass transfer of the solutes in the mobile phase, above and beyond the increase due to the turbulent flow. Secondly, the molecular motion caused by the radiation results in the onset of turbulent flow at lower flow rates than that usually observed, or what would be predicted by Reynolds number calculations. There are several advantages to running at a lower flow rate than typically used in turbulent chromatography; ideally, the lowest flow rate at which the flow is sufficiently turbulent to accomplish the fundamental goal of minimizing mobile phase mass transfer. First, these lower flow rates are more easily handled by chromatographic systems. Second, the lower flow rates further minimize the extent to which stationary phase mass transfer effects will be observed. And lastly, the lower flow rates are more efficient in a given length of column. To elaborate on the last point, it has been realized that the very high flow rates at which turbulent chromatography is generally conducted would require the use of longer columns (Pretorius and Smutz, 1966). This is because at higher flow rates, the analytes travel a longer distance between the time they enter the mobile phase and the time they return to the stationary phase. Therefore, the analytes “experience” less of the stationary phase. One may say that the effective length of the column becomes shorter as the flow rate increases beyond a certain point. In addition, the data presented above suggest that under turbulent conditions there is an additional mechanism that reduces the access of large molecules to the stationary phase, suggesting that the issue of efficiency for a given length of column is even more significant when dealing with large molecules under turbulent conditions. (It may be noted that this “flow-rate-dependent access” to the stationary phase exists even for conventional chromatography, yet there is nothing in the fundamental theories of chromatography to address this. One might consider whether there is any value in adding a factor to the fundamental resolution equation to adjust the length term with respect to the linear velocity at which one is running). It should be clarified that the flow rate used for microwave enhanced turbulent separations will still be considerably higher than for a conventional HPLC method. Therefore, a compromise is reached between obtaining the desired faster separations and minimizing both stationary phase mass transfer issues and the need to use excessively long columns.

The benefits of turbulent flow apply not only to the chromatographic separation; turbulent flow is also known to minimize broadening of peaks as they move through the tubing, connections and the detector cell, i.e., band broadening due to extra-column effects (De Pauw, Choikhet, Desmet, Broeckhoven, 2014; Berger 2011). Therefore, this should be considered in the overall system design.

It was mentioned that the dielectric polarization phenomenon affects polar molecules. Thus, for separations that make use of non-polar mobile phases, such as carbon dioxide, some percentage of polar modifier must be added to the mobile phase to observe these benefits, unless there is sufficient direct interaction of the radiation with the analytes. However, such separations are, in fact, usually run with some polar modifier present.

A New Chromatographic Mode: Diffusion-and-Turbulent-Dependent Size Exclusion-Chromatography (DT-SEC):

One of the more recent insights into the nature of turbulent chromatography, covered in the Background Discussion above, is that under turbulent conditions the retention of large molecules decreases. This phenomenon has been used for sample preparation to accomplish the removal of large molecules (as with the commercially available TurboFlow columns). However, use of this size selective mechanism for chromatographic purposes has not yet been reported. Such a novel method would therefore be a unique mode of separation. The method would preferably make use of a column with pores large enough to allow unhindered diffusion of all molecules being separated. Large molecules would elute earlier than small molecules as they would have less access to the stationary phase due to the diffusional and turbulent processes described previously. The column would most likely consist of relatively large diameter particles (50 μm, for example) and would be operated at high enough linear velocity so that turbulent flow would be achieved. In addition, it may be beneficial if the particles are of sufficiently strong construction so as not to deform during the separation. Just as with classical size exclusion chromatography, the conditions of the method should be chosen so as to minimize enthalpic interactions of the analytes with the column. It is envisioned that this method would be most useful for the separation of large molecules (i.e., the separation of “large” from “larger” from “larger still”). However, the method may have some usefulness for small molecules as well, and this would need to be evaluated experimentally. Given that this method would make use of the size selective retention characteristics due to both differences in diffusion as a function of the size of the analyte molecules as well as the differences in the way in which turbulent flow interacts with molecules as a function of size, it is aptly termed “Diffusion-and-Turbulent-Dependent Size Exclusion Chromatography” (or DT-SEC). It is interesting to note that with this technique, the flow rate at which the column is operated becomes a selectivity parameter that may affect the spacing of the peaks, which is not usually the case with isocratic separations. Furthermore, diffusional factors affect selectivity with this technique, whereas in other modes of chromatography diffusional factors are thought to affect only efficiency. When microwave radiation is used in combination with DT-SEC the technique may be given the name MDT-SEC (Microwave-Enhanced-Diffusion-and-Turbulent-Dependent Size Exclusion Chromatography).

Classical Modes of Chromatography that are Amenable to Use of Turbulent Conditions:

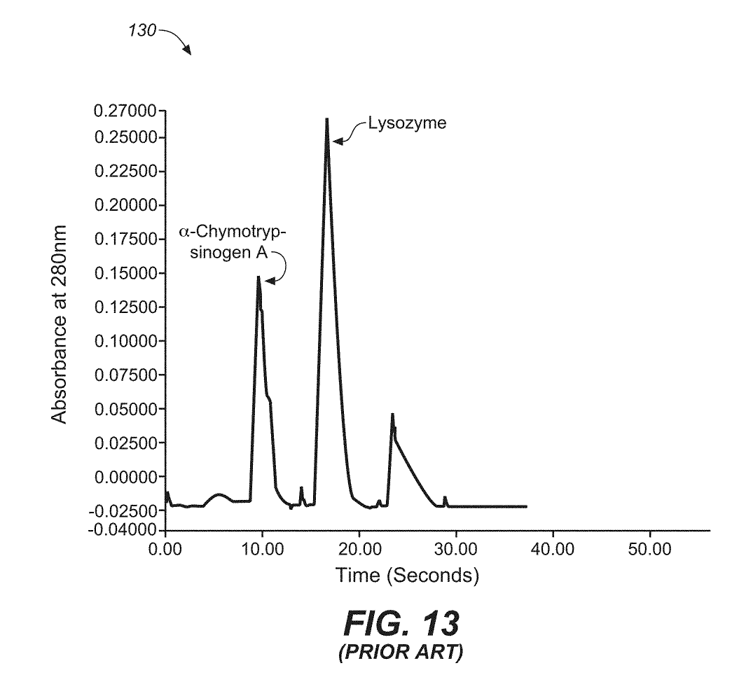

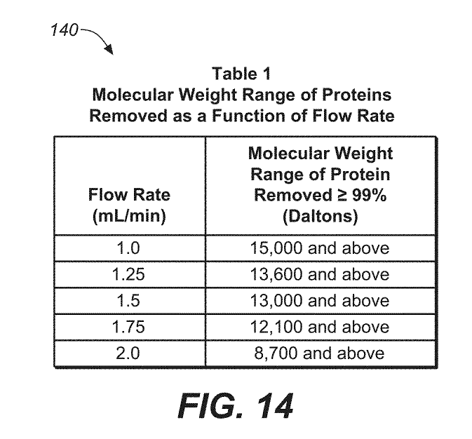

Keeping in mind one of the newer insights, considered in the Background Discussion above, that under turbulent conditions, there is a mechanism that results in retention being an inverse function of molecular weight, we may now revisit the question of which of the classical modes of chromatography could successfully exploit the benefits of turbulent chromatography. In many enthalpic separations, especially reversed phase separations, smaller analytes typically elute earlier than larger analytes. This is opposite to the diffusion-turbulent based mechanism, and therefore such methods are expected to be problematic under turbulent conditions, as the two modes of separation would work against one another. However, in any separation where larger analytes elute earlier than smaller analytes, turbulent chromatography could be successfully used. It is also expected that turbulent flow could be used successfully, with enthalpic methods, in cases where the analytes are not significantly different in molecular weight or when the differences are such that the effect of the diffusion-turbulent mechanism is not significant (in other words, the effect on retention is approximately equivalent for all analytes). Additionally, turbulent chromatography could be exploited for separations which elute one molecule at a time. In fact, an example of this was reported by Quinn et. al. (U.S. Pat. No. 5,795,469) where α-Chymotrypsinogen and Lysozyme were sequentially eluted from a cation exchange column with a step gradient: 0.2 M NaCl in the first step, and 2 M NaCl in the second. The resulting separation 130 is presented in FIG. 13. It may be noted that the run time was fast, the peaks were baseline resolved, and the peak widths were 4 to 5 seconds, suggesting the potential for very high efficiencies and speeds. It should also be reiterated that the flat flow profile that occurs under turbulent flow conditions makes these type of step gradients more feasible.

It is often the case with one-molecule-at-time methods that each analyte is minimally retained as it is eluting, and under those conditions, the benefits of turbulence would be observed, even in the absence of microwave radiation. This approach is probably more applicable to large molecules, due to the on/off mechanism by which they separate (or, alternatively, due to their high S values).

Lastly, it will be noted that the DT-SEC or MDT-SEC mechanism could be used in combination with classical size exclusion chromatography, if using a column that were composed of pores that only allowed molecules below a certain molecular weight to enter (as with a conventional SEC column), but where the particles are of larger diameter and sufficiently strong, and if the separation were run at a high enough linear velocity to induce turbulent flow.

In summary, the three keys to successful turbulent chromatography with enthalpic methods include:

1) Working with an enthalpic mode in which the analytes elute in reverse order of molecular weight (i.e., larger molecules elute earlier), or where the analytes are not significantly different in molecular weight, such that the diffusion-turbulent mechanism has an insignificant effect on the separation, or for methods where one molecule is eluting at a time. In the first case, the separation would be a function of the enthalpic mode as well as the diffusion-turbulent mechanism, as both factors have an effect on the extent of interaction of the analyte molecules with the stationary phase.

2) Applying microwave radiation. In most cases, it is suggested that this should be done in such a way as to avoid significant heating, so that a radial temperature gradient does not form in the column.

3) Using a fused core or monolithic column. High porosity monoliths may be ideal. Non-porous or open-tubular columns may be an option in certain situations, although there may be a significant loss of loadability and retention with such columns. Successful turbulent chromatography may be possible without microwave radiation in the following cases: a) for one-molecule-at-a-time methods where each analyte is minimally retained as it elutes; and b) when dealing with large molecules and using an open-tubular or non-porous column (assuming the method being used is consistent with the requirements of key 1 above). It is possible that some success could also be achieved with fused core or monolithic columns.

It may be noted from the discussion thus far that supercritical fluid chromatography (SFC) is, in some ways, particularly amenable to being used under turbulent conditions. Because the viscosity is lower, we expect (from equations 1 and 2) that turbulent flow would be more readily achieved at lower flow rates, which is beneficial in several respects as discussed above. And, as will be discussed with respect to a third embodiment of the inventive method, the application of microwave energy may also make it more feasible to use water as the primary modifier in an SFC separation.

It was suggested in U.S. Pat. No. 6,630,354 B2 that microwave radiation should be applied at lower powers and/or with short pulses, with intervals of rest in between, so as to avoid significant heating of the mobile phase. The reason is that if the temperature of the mobile phase is elevated significantly, a radial temperature gradient develops that will be harmful to the separation. However, a greater degree of energy can be applied when working with a turbulent chromatography system. There are two reasons for this: First, the higher linear velocities at which one is working means there will be less time for heat to accumulate. Second, the enhanced radial mass transfer means that the effect of any radial temperature gradient should be less detrimental as they effects would be averaged out, at least partly, as described in the discussion relating to FIG. 6.

Accomplishing Easier On-line Removal of Large Molecules:

In U.S. Pat. No. 9,804,133, to Stone, and co-pending U.S. patent application Ser. No. 15/400,473 (each incorporated in their entirety by reference herein), many compelling applications for the use of pre-columns are discussed. Any of these applications could be used similarly except where the columns would be designed to promote turbulent flow and would be operated under turbulent condition.

A particularly compelling application would be use of a pre-column followed by an analytical column to allow an easier alternative to the current approach for using turbulent flow to accomplish on-line removal of large molecule interferences. Such systems are generally designed with a valve which diverts the large molecules to waste during the first step of the process, and which is then switched such that the small molecules can be eluted and analyzed. An example of this would be the TurboFlow columns described earlier. In what follows the term ‘TurboFlow column’ will be used to refer to the column that serves to rapidly elute large molecules by virtue of the turbulent conditions that it generates, with the understanding that this would not necessarily be the commercial product known as a TurboFlow column, but could be any column which serves this function.

The complication with the approach described above is that the small molecules elute from the TurboFlow column with poor peak shapes (for all the reasons described earlier with respect to why turbulent flow chromatography has not been successful historically). Therefore, a second column (the analytical column) is usually needed to re-focus and then separate the small molecule analytes. Since a chromatographically strong solvent is used to elute the analytes from the TurboFlow column, poor focusing would be obtained if the sample were transferred directly to the analytical column. The typical solution is to combine this elution flow stream with another flow stream of chromatographically weak solvent, wherein, the flow from the chromatographically weak fluid line must be higher than that from the chromatographically strong fluid line to render the resulting (combined) mobile phase as chromatographically weak. In this way, efficient focusing of the analytes may occur at the head of the analytical column (Edge, 2003; Chassaing, Robinson, 2009; Herman, Edge, 2012; Crouchman, 2012).

Given the complex nature of this process, additional method development is required such that the flow rates and chromatographic strengths of the two fluid streams are properly balanced so as to allow the small molecules to be efficiently transferred from the TurboFlow column and focused at the head of the analytical column. Additionally, such setups generally require a specialized and dedicated instrument with two pumps and the necessary valving (Edge, 2003; Chassaing, Robinson, 2009; Herman, Edge, 2012; Crouchman, 2012). [0105]

The successful application of turbulent chromatography, as described in this application, would make it possible to use one column, operated under turbulent conditions, to accomplish both the removal of large molecules in the first step, and the subsequent chromatographic separation of the small molecules. While such an approach could work, it is likely that there would be one remaining problem with this type of setup. Although the small molecules would be retained during the first step of the process, they are likely to be somewhat spread out on the column and, therefore, less than optimal efficiency would result in the subsequent chromatographic separation.

A simple solution to this problem would be to utilize a setup with two columns in tandem: the first serving as both the TurboFlow column and as a pre-column, and the second being the analytical column. With this setup it would only be necessary for the flow to be turbulent during the initial loading step, as it is the nature of turbulent flow that results in reduced retention for the large molecules. During the subsequent transfer of analytes from the TurboFlow/pre-column to the analytical column, as well as during the separation on the analytical column, the flow could be either turbulent or laminar.

In order for the desired focusing to be accomplished, at the head of the analytical column, the linear velocity of the analytes on the TurboFlow/pre-column must be notably higher than their linear velocity on the analytical column, during the transfer. This was discussed in detail in the patents mentioned above. One scenario by which this could be accomplished would be if the TurboFlow/pre-column was less retentive than the analytical column (with the same mode of chromatography occurring on both columns). For example, if doing reversed phase chromatography, and the TurboFlow/pre-column is composed of a cyano phase and the analytical column is composed of a C18 phase. One may also consider using a large pore or non-porous column; or a high porosity monolith or an open-tubular column (including a support coated open-tubular columns) as the TurboFlow/pre-column as these type of column formats also serve to lower the retention of analytes. In addition, it may be beneficial if the internal diameter of the TurboFlow/pre-column were narrower than that of the analytical column, as this would further promote a higher linear velocity on the TurboFlow/pre-column.

A valve may be placed in between the pre-column and the analytical column in order to direct the large molecules to waste during the first step. Alternatively, the valve may be located after both columns. And, in fact, one may choose to use no valve at all (if there is no concern with respect to the large molecules entering the detector). Though, in this case, the analytical column would need to tolerate the high flow rates used during the loading step. Therefore, if non-turbulent conditions are being used for the analytical separation, a monolithic column may be a good choice.

It may be noted that the increased ability to use step gradients and fast gradients, under turbulent conditions, may further enable the effective use of this approach, as it may be desirable to utilize a step gradient to transfer the analytes from the TurboFlow/pre-column to the analytical column. And fast gradients are almost always desired for bioanalytical separations. This approach would allow a far more simple approach in comparison to the historical approach, described above, which requires additional method development and specialized and dedicated instrument with two pumps and valving. Given its somewhat reduced retention, the TurboFlow/pre-column may need to be longer than usual.

Several additional embodiments will now be discussed; each of which could be utilized under either turbulent of laminar conditions.

### Second Embodiment—Use of Microwave Radiation to Increase the Speed of Column Equilibration Following a Change of Mobile Phase

The second embodiment of the invention applies to the equilibration of a column after a change of mobile phase, e.g., the re-equilibration stage of a gradient run in either liquid or supercritical fluid chromatography. The process of equilibration is generally thought to require 10 column volumes or more, and therefore, requires a certain degree of time which adds to the overall analysis time. Researchers have shown recently that the process of equilibration can be as much as 65% diffusion controlled (J. Foley, 2014; J. Dolan 2015). This means that increasing the flow rate would have only a moderate effect on the rate of column equilibration (and would also result in more consumption of mobile phase, which is more costly and less environmentally friendly). By application of microwave radiation, the rate of mass transfer is increased, and therefore, the rate at which column equilibration occurs is accelerated.

### Third Embodiment—Use of Microwave Radiation to Increase the Speed at which Liquid or Supercritical Phases Mix Uniformly

The third embodiment of the invention is the use of microwave radiation to speed the process of two or more liquid or supercritical phases mixing with one another. It is known that when two different phases begin to mix, even when the phases are entirely miscible with one another, complete and uniform mixing does not occur immediately. As a result, when two phases are mixed together during a chromatographic separation there is an interval of time where the mobile phase will contain “packets” of one phase and “packets” of the other. And this has a negative effect on the chromatographic separation as some solutes experience a different mobile phase then other solutes, as they pass through the column. This phenomenon exists not just in binary systems but for ternary (containing three components) or higher order systems as well. Furthermore, in cases where the phases are marginally soluble with one another, the rate of mixing is expected to be even slower and the potential exists for stratification to occur even after the solvents have mixed.

A particularly noteworthy example of the difficulties that can result from this type of issue is Supercritical or Subcritical Fluid Chromatography, in cases where carbon dioxide is used as the primary mobile phase and one desires to add some percentage of a polar liquid (or modifier) to change the polarity or density of the mobile phase, or to interact with and pacify active sites on the column. Water has been shown to be a beneficial modifier. However, water is only soluble to the extent of less than 3% in carbon dioxide (with the exact percentage varying depending on the temperature and pressure being used). As a result of the limited solubility, most SFC separations use other modifiers such as methanol or isopropyl alcohol. However, there would be benefits to using water and carbon dioxide, either alone, or with only very minimal quantities of another modifier present. Firstly, with only water and carbon dioxide, or with very minimal quantities of another modifier present, it would be possible to use a flame ionization detector (FID). This is quite desirable as the FID detector has many positive attributes such as good sensitivity, a wide linear range, and essentially uniform response factors for most solutes. Generally, an FID detector is not useable with liquid or supercritical fluid separations. However, under these conditions it would be, as both carbon dioxide and water give virtually no signal with the FID and, therefore, would not contribute a significant background response. Secondly, water and carbon dioxide are very environmentally friendly solvents. The high degree of mass transfer and “mixing energy” that results from the application of microwave radiation would make the use of water as a modifier more feasible, such that these techniques could be conducted without the presence of an additional modifier, or with a very small quantity of additional modifier present.

### Fourth Embodiment—Use of Microwave Radiation to Reduce the Viscosity of a Liquid or Supercritical Fluid Mobile Phase

The fourth embodiment of this application is the use of microwave radiation to reduce the viscosity of the mobile phase in a Liquid or Supercritical Fluid Separation. The viscosity of a fluid is, in part, a function of the intermolecular forces between the molecules that constitute the fluid. For example, the viscosity of butanol is 2.95 cP and the viscosity of pentane is 0.24 cP, despite the fact that these molecules are very similar in size and shape. This is because the former is more polar than the latter and, therefore, the intermolecular forces between the molecules are stronger. It is known that increasing the temperature of a liquid results in a substantial drop in viscosity, due to the resulting higher kinetic energy of the molecules, which weakens these intermolecular interactions (Teutenberg in “High Temperature Liquid Chromatography”, RSC Publishing, 2010). It is thought that the application of microwave radiation would have a similar effect, due to the enhanced molecular motion that is caused. In particular, the unique nature of the alignment and randomization process that results from the application of microwave radiation, and the resulting rotation of the fluid molecules, would be expected to disrupt, or weaken, intermolecular interactions, which contribute to the higher viscosities of polar liquids. This should result in a lower viscosity and, consequently, a lower back pressure in chromatographic separations. This effect should work in the absence of any significant increase in temperature; but may be most pronounced if microwave radiation is applied in combination with some increase in temperature.

A subset of this embodiment would be the application of microwave radiation only during the intervals within a separation where peak-free regions of the chromatogram are being eluted, or perhaps where non-critical peak pairs are being eluted. This would have the effect of reducing the viscosity and allowing higher flow rates to be utilized during these time intervals. During these “peak free” or “non-critical peak” times of the separations one may not be concerned with the connection between the flow rate and the efficiency of the separation. Therefore, higher flow rates could be exploited, during these times, to speed the analysis.

### Fifth Embodiment—Use of Microwave Radiation to Apply Temperature Pulses to Selected Time Segments of the Separation

It has already been established that microwave radiation has the potential to heat liquids more rapidly than is possible by conventional heating methods (air ovens, block heaters, etc.). In addition, the use of microwave radiation makes it possible to heat only the mobile phase and analytes but not the column itself (assuming, of course, that the column and stationary phase particles are constructed of material that does not absorb microwave radiation to any significant degree. Thus, for example, columns made with stainless steel housing are probably not the most appropriate for this technique). Therefore, the time required for the system to subsequently cool is much shorter than with conventional heating methods, because once the hot liquid is “pumped away” most of the heat is gone as well. Generally, all that remains would be a moderately elevated temperature due to heat that was convectively transferred to the column housing and stationary phase particles.

Use of microwave radiation to accomplish temperature gradients has been presented in the literature (Terol, Maestre, Prats, and Todoli, 2012) and, therefore, is not claimed as part of this application. However, a related approach would be the application of temperature pulses to selected segments of the chromatogram to help optimize resolution. Thus far, this has only been accomplished by conventional heating methods (Causon, Cortes, Shellie, Hilder, 2012).

However, the use of microwave induced heating is ideally suited to accomplish these rapid temperature pulses as microwave radiation makes possible very fast increases in temperature. And, as mentioned above, faster rates of cooling are possible due to the fact that the microwave heats only the mobile phase and the analytes. It should be mentioned that use of insulating material, or a vacuum, either surrounding the column or as part of the column itself, is advisable with this technique since it would help to prevent radial temperature gradients from developing when heating of the mobile phase occurs. And, in fact, use of insulation in this way could be helpful for any application of microwave radiation to liquid or supercritical fluid chromatography.

What is claimed as invention is:

1. A method of enhancing turbulent flow chromatography in liquid or supercritical fluid separations for both retained and unretained solutes, comprising the step of applying microwave radiation to the chromatography column so as to enhance the molecular motion of the mobile phase molecules, lower the viscosity of the mobile phase, cause increased molecular motion of the analyte molecules within the mobile phase, minimize the residual laminar layer within a turbulent mobile phase, and increase the molecular motion of analytes within the stationary phase.

2. The method of claim 1, wherein the direction of the separation is not inconsistent with turbulent chromatography.

3. The method of claim 1, further including the step of using a fused core column.

4. The method of claim 1, further including the step of using a monolithic column.

5. The method of claim 1, further including the step of using a high flow rate.

6. The method of claim 5, wherein the mobile phase includes polar liquids.

7. The method of claim 1, further including the step of separating molecules according to their size using classical size exclusion chromatography.

8. The method of claim 7, wherein the size exclusion step is accomplished using a column composed of pores that allow only molecules below a certain molecular weight to enter and the separation is run at a linear velocity sufficiently high to induce turbulent flow.

9. The method of claim 1, wherein the microwave radiation enhances turbulent flow conditions already present in the column at a lower flow rate.

11. The method of claim 1, wherein the step of applying microwave radiation is performed only during the intervals within a separation where peak-free regions of the chromatogram are being eluted.

12. The method of claim 1, wherein the step of applying microwave radiation is performed only when non-critical peak pairs are being eluted.

13. The method of claim 1, wherein the chromatography column and the stationary phase are constructed of materials that do not absorb microwave radiation, wherein the microwave radiation directly heats only the mobile phase and analytes but not the column and any temperature elevation to the column is due to heat convectively transferred to the column housing and stationary phase particles.

14. An enthalpic method of enhancing turbulent column chromatography, comprising the steps of:
providing a fused core or monolithic column;
applying microwave radiation to the column; and
eluting analytes in reverse order of molecular weight, such that larger molecules elute earlier than smaller molecules.

15. The method of claim 14, wherein a high porosity monolithic column is employed.

16. The method of claim 14, wherein the step of applying microwave radiation does not form a radial temperature gradient in the column.

17. A method of enhancing turbulent column chromatography, comprising the step of applying microwave radiation to a chromatography column following a change of the mobile phase in a re-equilibration stage of a gradient run in either liquid or supercritical fluid chromatography so as to increase the rate of mass transfer and the speed of column equilibration.

18. A method of enhancing turbulent column chromatography, comprising the step of applying microwave radiation to a chromatography column to increase the speed at which two or more liquid or supercritical phases mix uniformly.

20. The method of claim 19, further including the steps of:
using carbon dioxide as the primary mobile phase; and
adding a polar liquid modifier to change the polarity or density of the mobile phase, or to interact with and pacify active sites on the column.
